(19) United States
(12) Patent Application Publication
(10) Pub. No.: US 2013/0281077 A1
(43) Pub. Date: Oct. 24, 2013

(54) Service management platform for configuring, monitoring, and managing mobile devices

(71) Applicant: NQ Mobile Lux S.A., Luxembourg (LU)

(72) Inventors: Shihong Zou, Beijing (CN); Yu Lin, Beijing (CN); Wenyong Shi, Beijing (CN); Ian Andersen, Dallas, TX (US); Christopher Conrad Edwards, Dallas, TX (US); Da Fu, Beijing (CN); Jian Hong Ou, Beijing (CN); Renjith Ramachandran, Dallas, TX (US); Victoria Repice, Dallas, TX (US)

(21) Appl. No.: 13/842,096

(22) Filed: Mar. 15, 2013

Related U.S. Application Data
(63) Continuation-in-part of application No. 13/758,766, filed on Feb. 4, 2013.
Application No. 13/758,766 is a continuation of application No. 12/677,261, filed on May 12, 2010, now Pat. No. 8,369,845.

(30) Foreign Application Priority Data
Sep. 10, 2007 (CN) 200710121575.9

(51) Int. Cl. H04W 8/22

(52) U.S. Cl. CPC H04W 8/22
USPC 455/418

(57) ABSTRACT

A service management platform provides a manager device the ability to provision, manage, and monitor managed devices through a manager device interface to the service management platform. The service management platform allows for a manager device to configure and modify various profiles by determining one or more governing policies to be associated with respective profiles. The service management platform allows for the manager device to provision managed devices by the service management platform applying selected profiles to respective selected devices. The service management platform further allows for the manager device to monitor one or more managed devices by providing managed device usage data to the manager device, based on requests originating at the manager device.

### CROSS REFERENCE TO RELATED APPLICATIONS

This application is a continuation-in-part of U.S. patent application Ser. No. 13/758,766, filed Feb. 4, 2013, which is a continuation of U.S. patent application Ser. No. 12/677,261 filed May 12, 2010, issued as U.S. Pat. No. 8,369,845 on Feb. 5, 2013, each of which is hereby incorporated by reference. U.S. patent application Ser. No. 12/677,261 is a national stage entry of Patent Cooperation Treaty No. PCT/CN2008/001504 filed on Aug. 21, 2008 and claims priority to Chinese Application No. 200710121575.9 filed Sep. 10, 2007, both of which are also hereby incorporated by reference.

### FIELD OF THE INVENTION

The present disclosure relates to a method and system for conveniently configuring, monitoring, and managing a managed device by a manager device, and belongs to the technical field of mobile communications, mobile services, and computer services.

### TECHNICAL BACKGROUND

With the rapid development of microelectronic techniques and computer technology, the intelligence level of mobile chips has reached an unprecedented height. Many smart-phones are powerful personal computers themselves. Powerful mobile services have mushroomed one after another with the rapid development of mobile telephone hardware. For example, multimedia services (audio play, photo and video, audio-tools, graphics and images, various ring, ring DIY, video clips, etc.), system tools (system management, file management, tray safe, Chinese IME (Input Method Editor), Infrared and Bluetooth, etc.), application software (call auxiliary, business card memo, calendar clock, screensavers desktop, life application and documentation tools, etc.), network tools (network browser, instant messaging, e-mail tool, network support, etc.), and other classes and services, such as mobile telephone games, GPS, e-book room and antivirus software, etc., are developing rapidly Moreover, various kinds of new mobile services are springing up continuously, spreading to and penetrating hundreds of millions of mobile device users. Furthermore, many other new mobile device communication services that use a mobile device as the carrier are being researched and developed rapidly and continuously, and will be accepted and used by a number of users soon.

Traditional mobile services focus on individual mobile devices, and services should be reinstalled and reconfigured manually when the mobile device is updated. However, mobile phones are updated more and more frequently nowadays. It is inconvenient for users to install and configure mobile telephone service software manually because of the various kinds of brands, models, styles and functions of mobile telephones. Furthermore, computer knowledge is limited for the general public, which limits the popularization of mobile device services.

Moreover, because of the focus on services at the individual mobile device level and the increase in mobile device users, a party interested in managing or monitoring another's mobile device usage, content, and access is limited to a physical inspection of the device itself, through permission of the device user. For example, a parent wanting to monitor and manage their child's mobile device can only do so by inspecting the device itself, and still may not be aware of usage patterns and information accessed. The same is true for businesses wishing to monitor employee work related mobile devices.

### SUMMARY

The service management platform systems and methods provided in the present disclosure provide a manager device the ability to provision, manage, and monitor managed devices through a manager device interface associated with the service management platform.

According to an aspect, provisioning mobile device services for managed mobile devices, at a manager mobile device via a service management platform, may include receiving manager user information from the manager mobile device via a manager mobile device interface; initializing the management application at the manager mobile device interface; receiving service profile from the manager mobile device interface; storing the service profile received from the manager mobile device interface; and provisioning the mobile devices by applying the service profile. The service profile(s) may be governed by one or more management policies;

The managed mobile devices may be different mobile devices than the manager mobile device. The managed mobile devices may be associated with respective managed device users, and the managed device users may be different than a user associated with the manager mobile device.

The provisioning may further include receiving a managed device identifier from the manager mobile device interface; and storing the managed device identifier received from the manager mobile device interface. The managed device identifier may be a managed device number, mobile identification number (MIN), hardware identification number, SIM card identity, electronic serial number, or an international mobile equipment identity (IMEI).

The provisioning may further include receiving a request for provisioning a managed mobile device. The request may include a managed device selection and a service profile selection. The request may be stored at the service management platform database. Storing the request may include storing the request for selected managed device identifiers associated with the respective selected service profiles.

Provisioning may also include identifying a selected managed mobile device based on the managed device selection. The selected service profile may be applied to the selected managed mobile device based on the service profile selection.

Provisioning may be performed in response to receiving a request originating from the mobile manager device.

According to another aspect, modifying mobile device services for managed mobile devices, at a manager mobile device via a service management platform, may include receiving manager user information from the manager mobile device via a manager mobile device interface; initializing the management application at the manager mobile device interface; receiving a modified service profile from the manager mobile device interface; storing the modified service profile received from the manager mobile device interface; and provisioning the managed mobile devices by applying the modified service profile. The modified service profile may be governed by modified management policies.

The managed mobile devices may be associated with respective one or more service profiles, and the modified management profiles may be applied to managed devices associated with the service profiles.

According to another aspect, monitoring may include receiving manager user information from the manager mobile device via a manager mobile device interface; initializing the management application at the manager mobile device interface; receiving a managed device selection from the manager mobile device interface; receiving a managed device information request from the manager mobile device interface; and transmitting managed device data associated with the managed device based on the managed device information request. The managed device data received from the managed device may include managed device usage data.

Monitoring may also include requesting and receiving managed device data from a managed device associated with the managed device selection and based on the managed device selection. Monitoring may further include receiving a modified service profile from the manager mobile device interface. The modified service profile may include modified management policies based on the managed device data received from the managed device.

Usage data may include trend charts, service usage, and application usage associated with the managed device.

The managed device data may be transmitted to the manager mobile device interface substantially in real-time.

Further, the modified service profile received from the manager mobile device interface may be stored at a service management platform database. And the managed mobile devices may be further provisioned by applying the modified service profiles to respective managed mobile devices.

### BRIEF DESCRIPTION OF THE DRAWINGS

FIG. 1 is a schematic diagram of network system for managing mobile device services, according to the present disclosure;

FIG. 2 is a schematic diagram of a service management platform of the network system for managing mobile device services, according to the present disclosure;

FIG. 3 is an operating and timing diagram showing the subscription of mobile telephone service software, according to the present disclosure;

FIG. 4 is an operating and timing diagram showing the configuration of mobile telephone service software parameters, according to the present disclosure;

FIG. 5 is an operating and timing diagram showing the movement of mobile telephone service software to the new mobile telephone, according to the present disclosure;

FIG. 6 is an operating and timing diagram showing the movement of the original mobile telephone service software to the new mobile telephone as a whole, according to the present disclosure;

FIG. 7 is an operating and timing diagram showing subscription to mobile telephone service software, according to an embodiment of the present disclosure;

FIG. 8 is a flow diagram showing activation and configuration of an account for managing a managed device, according to an embodiment of the present disclosure;

FIG. 9 is a flow diagram showing management of a managed device, according to an embodiment of the present disclosure; and

FIG. 10 is a flow diagram showing monitoring of a managed device, according to an embodiment of the present disclosure.

### DETAILED DESCRIPTION

The present disclosure is further described below with reference to the figures to clarify the object, technical solution and advantages of the disclosure.

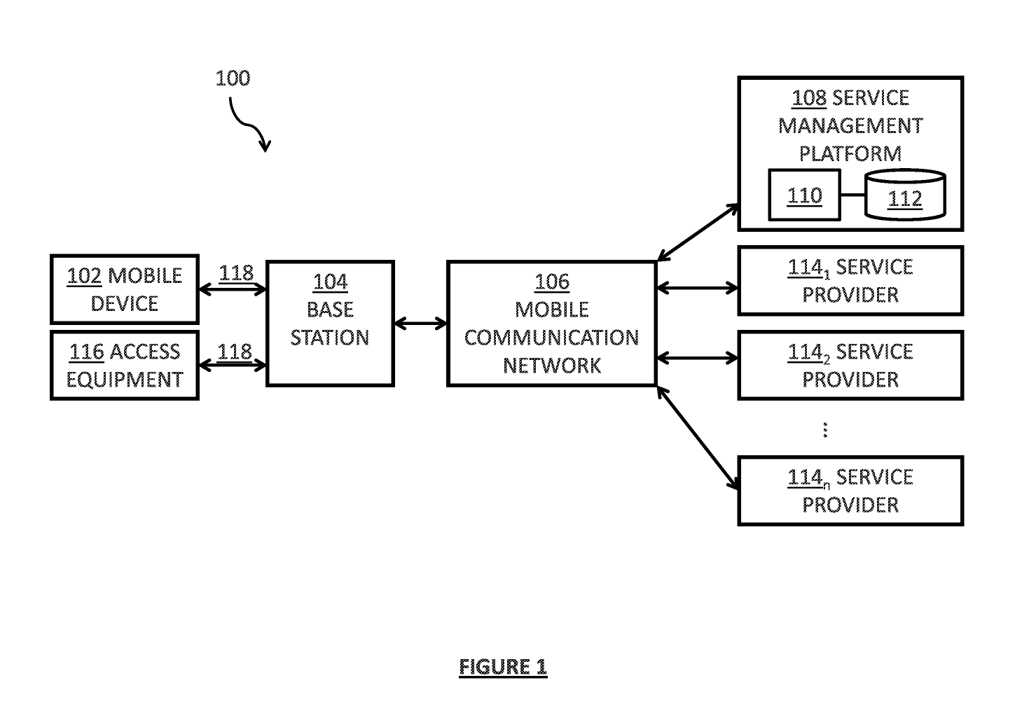

FIG. 1 is a schematic diagram of network system according to the disclosure. The network system 100 of the present disclosure allows for conveniently subscribing, configuring and moving a mobile telephone software service focused on a user. The network system 100 includes a mobile communication network 106, base station 104, service management platform 108, service providers 114₁, 114₂, . . . 114ₙ, access equipment 116 and mobile device 102. The mobile device 102 may be a mobile telephone, tablet, or any mobile communication device. The mobile communication network 106 connects users through local relays or base stations 104.

Service providers 114₁, 114₂, . . . 114ₙ are in communication with mobile communication network 106 over a network a network, for example, the internet or world wide web. Service providers may include any application providers, for example, APK providers. The service management platform 108 is in communication with the mobile communication network 106 and includes a service management platform server 110 and a service management platform database 112. In an embodiment, the service management platform 108 provides for software service management on a mobile device 102 or access device 116. In another embodiment, the service management platform 108 provides for software service management of a first user's mobile device or access device via a second user's mobile device or access device.

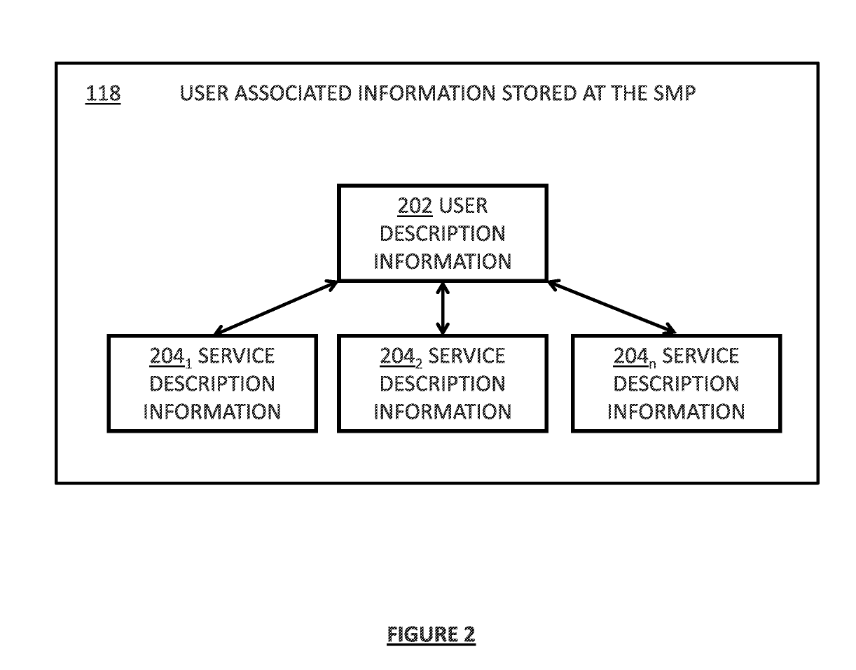

The service management platform 108 backs up and stores description information 118 received from the mobile device 102 and/or access equipment 116 in the service management platform database 112. Referring to FIG. 2, the description information 118 may include, but is not limited to, user description information 202 and service description information 204₁, 204₂, . . . 204ₙ. Referring back to FIG. 1, the description information 118 relates to all kinds of mobile telephone software services associated with a user's mobile device 102 and is stored in the database 112 associated with the service management platform 108. The service management platform 108 manages this information and may identify a mobile device 102 or other access equipment 116 accessing the service management platform 108 and permits authorized user mobile devices 102 or other access equipment 116 corresponding service.

The access equipment 116, through which a user logs on to the service management platform 108, may select a suitable mode to modify the description information 118, and may subscribe or configure all kinds of mobile telephone software services and the description information 118 associated therewith. The access equipment 116 may be a mobile telephone, computer, tablet, other mobile device, telephone, or interactive voice response (IVR) device. Different types of access equipment 116 can log on to the service management platform 108 in different ways. For example, a computer may access the service management platform 108 through a service management platform 108 web browser or client. A mobile device 102 may access service management platform 108 via the internet through different access points, including GPRS, EDGE, CDMA, short message, multimedia message, mobile application, mobile service, or voice channel, and a user can also dial a customer service support line and communicate with customer service through a fixed-line telephone or mobile telephone 102. Alternatively, a user can operate under the guidance of an interactive voice response (IVR) device to complete the corresponding operation of accessing service management platform 108 through a computer by customer service or the IVR device based on the needs of the user. In an embodiment, a retail outlet for mobile devices 102 provides the access equipment 116 so that a user may initiate device management upon purchase of a mobile device 102 while still in the store.

Referring now to FIG. 2, a microelectronic chip in the mobile telephone 102 may store the user description information 202 for uniquely identifying each user and the service description information 204₁, 204₂, . . . 204ₙ for all kinds of mobile device software services that the user has configured. In an embodiment, each set of service description information 204₁, 204₂, . . . 204ₙ corresponds to a kind of mobile telephone software service.

In the disclosed system, a mobile device user has a set of user description information 202 and several sets of service description information 204₁, 204₂, . . . 204ₙ. User description information 202 is used to record a user's personal private information and his/her mobile telephone hardware identity, including, but not limited to: user's unique identity and password, the mobile device hardware identities (e.g., International Mobile Equipment Identity (IMEI) and SIM card identity IMSI), a user's age, a user's sex, contacts, personal hobbies and expertise. The service description information 204₁, 204₂, . . . 204ₙ is used to record and set modality, function, restrictions, and configuration parameters for the respective mobile device service software, or other individualized information relating to the respective mobile device service software. For example, the service description information may include a black list and/or white list for a mobile device 102, restrictions on receiving spam messages in an anti-disturbance service or e-mail service, modes of refusing spam, key exchange algorithms, public key, ended to end encryption for transmitted messages, access restrictions (e.g., restricted website access), download and upload rights, time restrictions, and other use restrictions. Each software service for the mobile device 102 corresponds to one set of service description information 204₁, 204₂, . . . 204ₙ.

Referring to both FIGS. 1 & 2, the present disclosure, all of the user description information 202 and service description information 204₁, 204₂, . . . 204ₙ are also stored and managed in the service management platform 108. The user may access the service management platform 108, and may modify the user description information 202 and service description information 204₁, 204₂, . . . 204ₙ after identity authorization. Thus, it is convenient for the user to subscribe to mobile device software, configure the software service, manage the software service, and move the services to another mobile device as a whole. Further, a user may initialize, monitor, and manage another device through the service management platform 108.

In an embodiment, the disclosure provides a method for a user to conveniently subscribe, configure, manage, monitor, and move a mobile device software service, focusing on a user's profile and information. The implementing method regards all kinds of mobile device service software as the carrier of the service. After installing and starting a mobile device service, a user's mobile device 102 sends user description information 202 and service description information 204₁, 204₂, . . . 204ₙ related to the mobile device 102 to the service management platform 108. The user may log on to the service management platform 108 through access equipment 116 and subscribe to various mobile device services. All kinds of functionality is available, including a user interface to the service management platform 108, after identity authorization. The user may configure service parameters through access equipment 116, and after subscription or a configuration operation, may download the mobile device service software or service description information 204₁, 204₂, . . . 204ₙ from the service management platform 108 and install it to the user's mobile device 102. The user can also log on to the service management platform 108 through a new mobile device when the mobile device is changed. All mobile device service and service description information 204₁, 204₂, . . . 204ₙ used in the original mobile telephone can be moved to the new mobile telephone selectively or as a whole after identity authorization.

For the sake of safety, in an embodiment, the new mobile device is authenticated before each operation in the disclosed method. The identity authorization comprises at least confirmation of a username/password, and hardware identity of the mobile device identity (e.g., International Mobile Equipment Identity (IMEI) and SIM card identity IMSI, etc.), and the like.

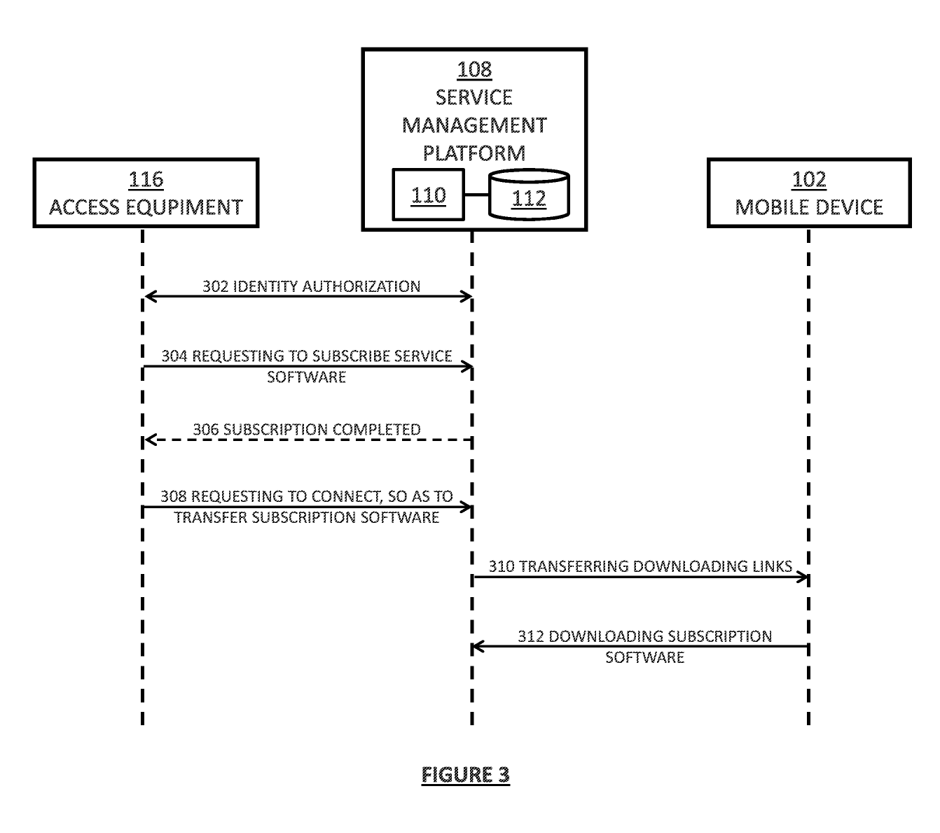

FIG. 3 is an operating and timing diagram showing the subscription of mobile telephone service software according to the disclosed methods. The operation of subscribing to the mobile device software service in the disclosure may include subscribing to a mobile device software service through access equipment 116. The information of the subscribed mobile device software service may include: the interface of the software service (including background picture, prompt text and/or warning tone, etc.), all kinds of functions of related software services, including obligatory functions and optional functions. The mobile device software service is transferred to a user's mobile device 102 to install for use by various means after subscription. The detailed subscribing actions may include the following:

The user logs on to the service management platform 108 through access equipment 116, and the user's identity is authorized at action 302. The user requests to subscribe to a mobile device software service at action 304.

The service management platform 108 performs the subscription operation of the mobile device software service, and at action 306 sends a message to the original access equipment 116 to inform the user that the subscription of the mobile device software service is completed after the subscription operation.

At action 308, the user, through the access equipment 116, requests the service management platform 108 to transfer the subscribed mobile device service software.

At action 310, the service management platform 108 sends downloading links to the equipment, (e.g., mobile device 102, PC computer, etc.) that the user appointed.

After the subscribed mobile device service software is downloaded at action 312 via the equipment that the user appointed (e.g., mobile device 102), the user installs it for use at the mobile device 102. The modes of downloading may include: clicking to download and installing through the user mobile device 102 after the service management platform 108 sends a PUSH message; accessing the internet through a computer to download and transmit to the mobile device 102; or accessing the internet through the mobile device 102 or for downloading.

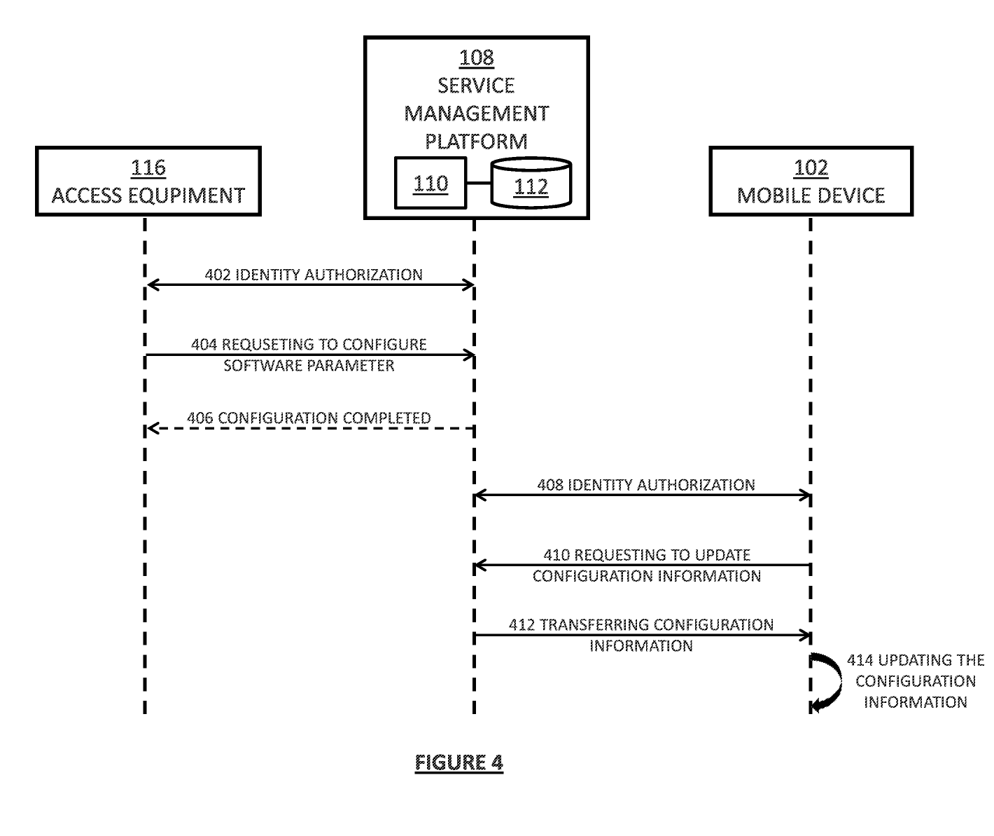

FIG. 4 is an operating and timing diagram showing the configuration of mobile device service software parameters according to the disclosure. The operation of configuring the service parameters of the mobile device software service in the disclosure may include configuring service parameters of the mobile device software service through access equipment 116. The configuration parameters used for service description information 204₁, 204₂, . . . 204ₙ (see, e.g., FIG. 2) may include: a backup cycle of service description information 204₁, 204₂, . . . 204ₙ, frequent automatic detection and updates of software services, mode for accessing the network, or other individualized service information related to the service, such as black and white lists, modes of refusing SPAM, subgroups of the address list, contact lists, an anti-disturbance service of the mobile device, safe address list, public keys, short-message encryption service of the mobile telephone, and so on. Additional configuration information can be downloaded through access equipment 116 after configuration so as to complete the configuration of service parameters of the mobile device software. The detailed configuration actions may include the following:

The user logs on to the service management platform 108 through access equipment 116, and the user's identity is authorized at action 402. The user requests to configure the software parameter at action 404.

The service management platform 108 performs the configuration operation of the mobile device software service, and at action 406 sends a message to the original access equipment 116 to inform the user that the parameter configuration of the mobile device software service is completed after the configuration operation.

At action 408, the user accesses the service management platform 108 through mobile device 102, and the user's identity is authorized. At action 410, the user requests to update corresponding service parameter configuration information through the corresponding menu items/keys of the mobile device service software.

At action 412, the service management platform transfers the new configuration parameters of the mobile device software service to the user mobile telephone 102.

At action 414, the mobile telephone service software in the user mobile telephone 102 updates the corresponding service parameter configuration information after receiving the new configuration information.

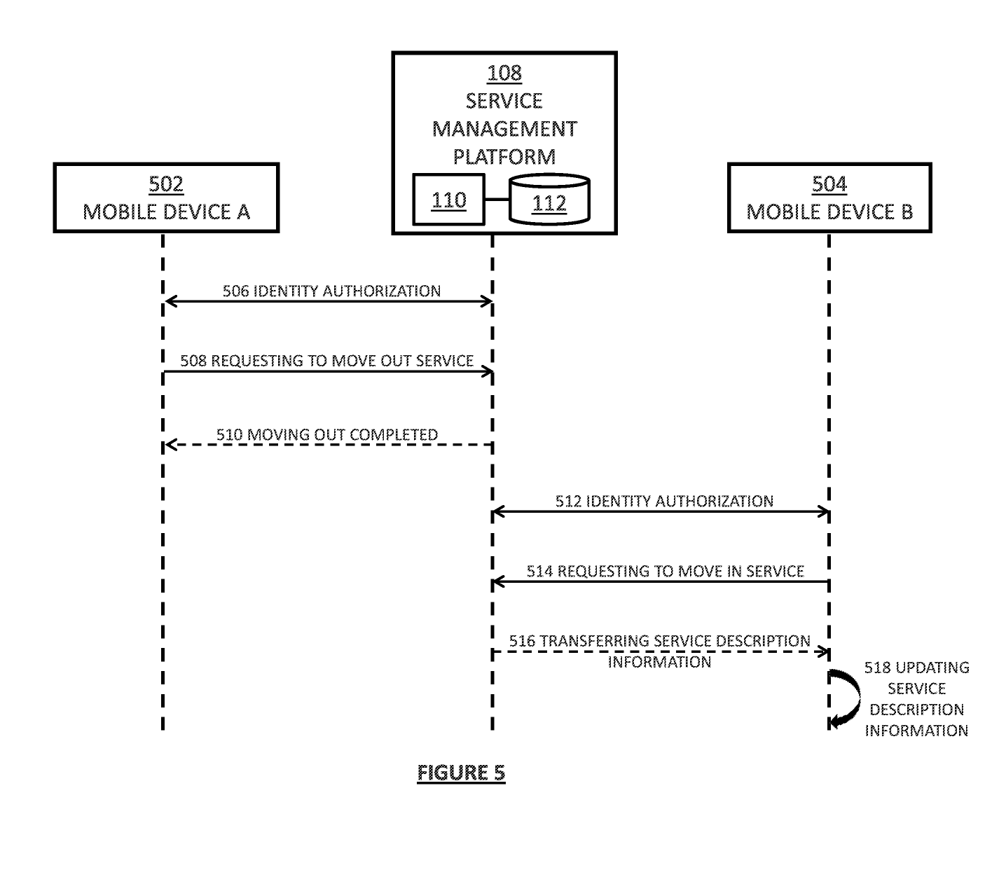

FIG. 5 is an operating and timing diagram showing the movement of mobile device service software to the new mobile device according to the disclosure. The disclosed operation of moving a mobile device software service includes moving the mobile device software service and the description information (including various favorite setting and configuration parameters, etc.) from an original mobile device to a new mobile device when the user changes mobile devices. The user may obtain consistent services from different mobile devices and the software services may be conveniently and consistently transferred irrespective of the type of mobile device from the perspective of the user. The detailed moving actions may include the following:

The user's original mobile device A 502 logs on to the service management platform 108, and the user's identity is authorized at action 506. The user requests to move out one or more mobile device software service(s) from the original mobile device A at action 508.

The service management platform 108 responds and operates the request, and informs the original mobile device A 502 that the operation of moving out the one or more mobile device software service(s) from the original mobile device A is completed at action 510.

The user's new mobile device B 504 logs on the service management platform 108, and the user's identity is authorized at action 512. The user requests to move the one or more mobile device software service(s) in the new mobile device B at action 514.

At action 516, the service management platform 108 responds and operates the request, and sends service description information 204₁, 204₂, . . . 204ₙ of the one or more mobile device software service(s) to the new mobile device B 504.

At action 518, the new mobile device B 504 updates local service description information 204₁, 204₂, . . . 204ₙ of the one or more mobile device software service(s).

Since some mobile device software services can be run on several mobile devices simultaneously, when these mobile device software services are moved to a new mobile device, it may not be necessary to remove them from the original mobile device, thus the above steps at actions 506, 508, and 510 may be omitted. Furthermore, as long as the mobile device B 504 passes the identity authorization, if a user wishes to move substantially all of mobile device software service from the mobile device A unconditionally, then the steps at actions 506, 508, and 510 may also be omitted.

When the user purchases or uses several kinds of mobile device software services, the systems and methods of the present disclosure provide for moving all kinds of software services as a whole. The disclosure makes it convenient for the user to move software services to a new mobile device at one time. In the operation of moving all kinds of software services to a new mobile device, the strategy of moving out the services is similar to that of the movement of a single mobile device service. A first embodiment provides for moving all kinds of mobile device software services in the original mobile device A 502 together to the new mobile device B 504 unconditionally. A second embodiment provides for moving all the rest of the mobile device software services to the new mobile device B 504 after moving out the related mobile device software services from the original mobile device A 502.

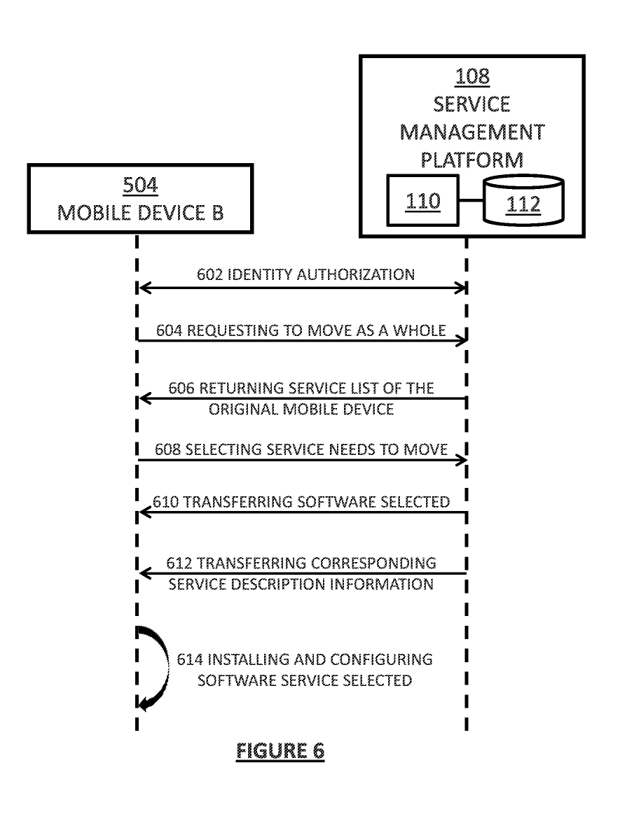

Referring to FIG. 6, the steps of the first embodiment are described as follows:

The user's new mobile device B 504 logs on the service management platform 108, and the user's identity is authorized at action 602. The user requests to move the mobile device services as a whole at action 604.

The service management platform 108 responds to the request to move all the mobile device services as a whole, and, at action 606, returns the list of all kinds of mobile device software services to the new mobile device B 504.

At action 608, the user selects the mobile device software services to be moved to the new mobile device B 504 and informs the service management platform 108.

The service management platform 108 transfers the selected mobile device service software and service description information 204₁, 204₂, . . . 204ₙ to the new mobile device B 504 at actions 610 and 612.

At action 614, the new mobile device B 504 locally installs and configures the mobile device service software and service description information 204₁, 204₂, . . . 204ₙ transferred by the service management platform 108.

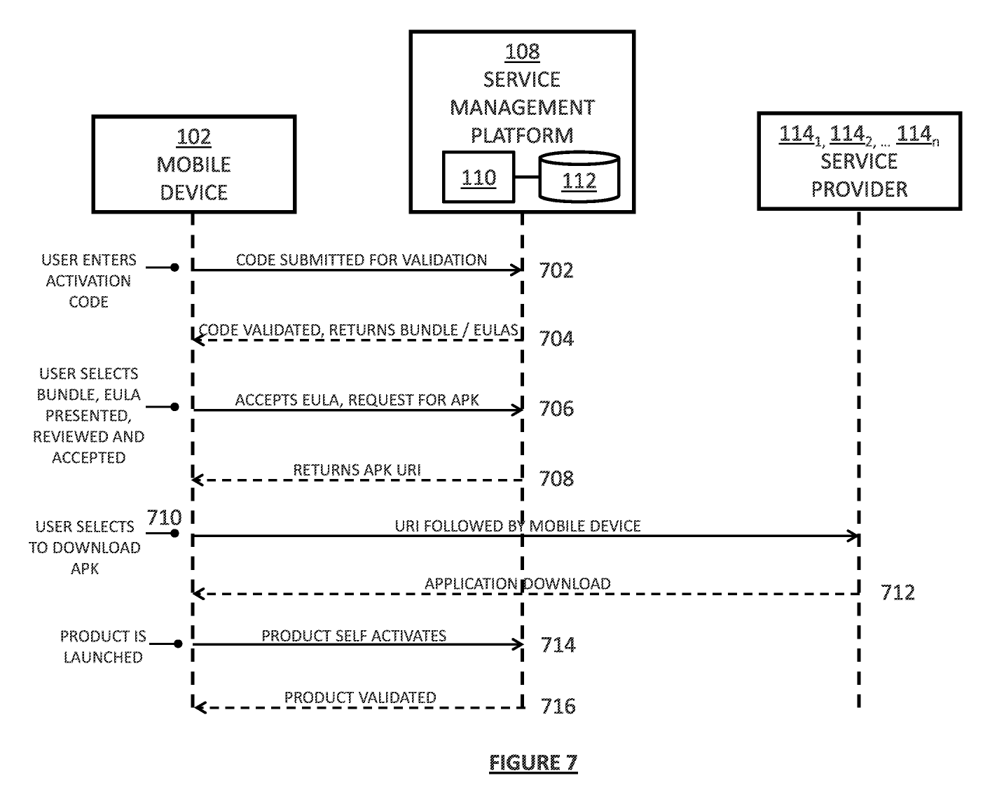

FIG. 7 is an operating and timing diagram illustrating another embodiment for subscribing to mobile device service software. The detailed actions may include the following:

At action 702, the service management platform 108 receives a request of a user for subscription to mobile device service software. In an embodiment, the request of the user comprises an activation code associated with service description information 204₁, 204₂, . . . 204ₙ submitted for validation by the user at a mobile device 102.

At action 704, the activation code is validated and the service management platform 108 transfers a bundle of data associated with the mobile device service software to the mobile device 102 of the user. In an embodiment, the bundle of data includes an end user license agreement (“EULA”).

At action 706, the service management platform 108 processes a request of the user for subscription to the mobile device service software (e.g., APK) and determines service description information 204₁, 204₂, . . . 204ₙ related to the mobile device software and the mobile device 102 of the user based on the request. In an embodiment, the service management platform 108 receives the user's acceptance of the EULA. In a further embodiment, the service management platform 108 receives a request for subscription to the mobile device service from the mobile device 102.

At action 708, the service management platform 108 initiates a transfer of the mobile device service software to the mobile device 102 from a software service provider 114₁, 114₂, . . . 114ₙ (e.g., an APK provider) to the mobile device 102 of the user. In an embodiment, the service management platform 108 initiates a transfer of the APK provider's uniform resource identifier (“URI”) to the user at action 708. In another embodiment, the service management platform 108 provides to the mobile device 102 a link for the user to click to download the software service. At action 710, the user selects to download the APK and/or clicks the link to download the software service. At action 712, the service provider 114₁, 114₂, . . . 114ₙ provides the software service (or APK) to the user's mobile device 102 via download. In a further embodiment, the service management platform 108 may send a PUSH message including the link for the user to click to download the software service. The product is activated and launched onto the mobile device 102.

At action 714, the service management platform 108 receives and stores user description information associated with the mobile device 102 of the user. In an embodiment, the service management platform 108 receives a notification from the mobile device 102 of the user that the software service is installed.

At action 716, the service management platform 108 validates the software service.

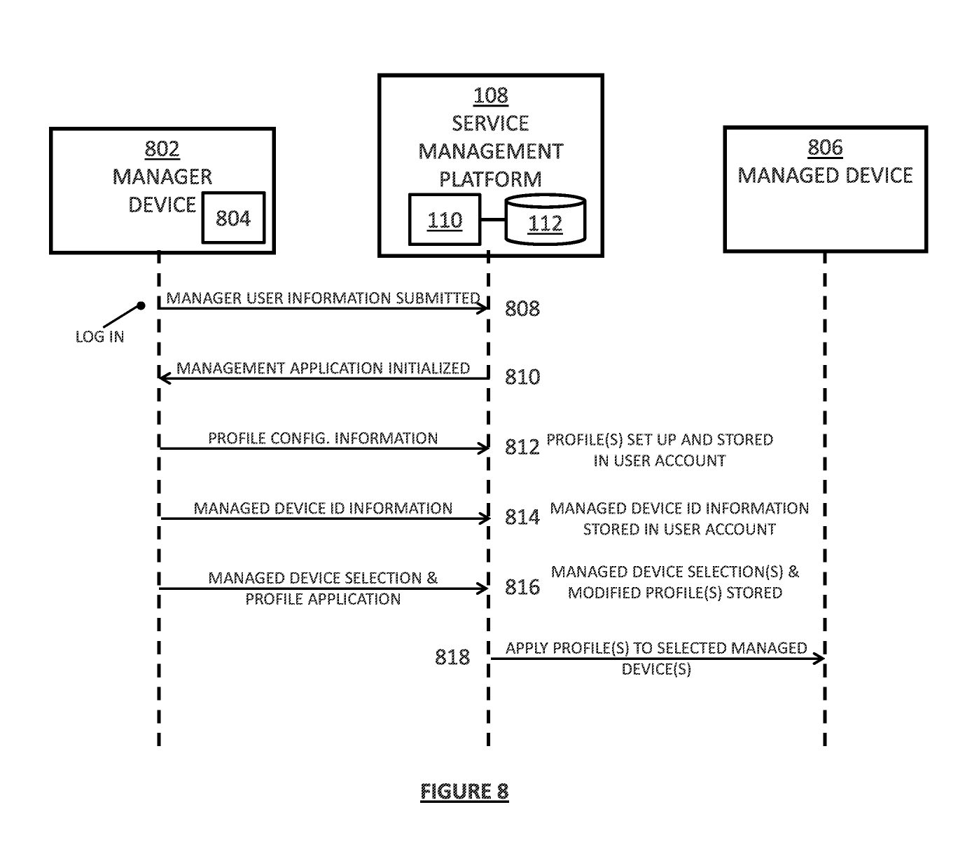

FIG. 8 is an operating and timing diagram showing activation and configuration of management profiles for a managed device 806. Profiles for managed devices 806 are configured at a service management platform 108 via a manager interface 804 of a manager device 802.

Profiles for the managed devices 806 are governed by one or more selected policies. Policy examples may include time restrictions, internet restrictions, website restrictions, limits on a number of text messages, password requirements, location tracking, download restrictions, etc. Further, a plurality of profiles, for provisioning one or more respective managed devices 806, may be configured and stored at the database 112. The detailed activation actions may include the following:

Manager device 802 logs in to a user account at the service management platform 108 via the manager interface 804. The manager device 802 may be a mobile telephone, computer, tablet, or similar device. The manager interface 804 may be a mobile phone application, web browser application, or the like. Thus, the manager device 802 requests for activation and configuration may originate at a mobile device. At action 808, service management platform 108 receives manager user information (e.g., user name, password) provided at the manager interface 804.

At action 810, the service management platform 108 initializes a management application for presentment of content at the manager interface 804. The service management platform 108 receives profile configuration information associated with one or more profiles from the manager device 802 at action 812. One or more profile(s) is thereby set up and stored in a manager user account in database 112 at the service management platform 108, based on the profile configuration information received at action 812. The one or more profiles stored in the database 112 are thus governed by one or more user-selectable policies.

At action 814, the service management platform 108 receives managed device identification information associated with one or more respective managed devices 806. Managed device 806 may be a mobile telephone, tablet, computer, or similar device. Further, there may be a plurality of managed devices 806 associated with a manager device 802. Thus, the manager device 802 may manage a plurality of managed devices 806 via the service management platform 108. Further, in an embodiment, manager device 802 and managed device 806 have different users. In an embodiment, at action 814, the service management platform 108 receives one or more managed device identifiers from the manager mobile device interface 804. The managed device identifier may include one or more of managed device number, mobile identification number (MIN), hardware identification number, SIM card identity, electronic serial number, and international mobile equipment identity (IMEI), or a service management platform managed device number. The managed device identification information received at action 814 is stored in the manager user account in database 112 at the service management platform 108 and is associated with a respective managed device 806.

At action 816, the service management platform 108 receives managed device selection and profile application information from the manager device 802, and the service management platform 108 stores the managed device selection and profile application information in the manager user account in database 112. The managed device selection may include a selection of one or more managed devices. The profile application information may include one or more profiles to be associated with one or more respective managed devices. At action 818, the service management platform 108 applies the profile(s) to the selected managed device(s) 806, thereby provisioning the managed device(s) 806 using on a profile. In effect, the managed device(s) 806 are governed by policies associated with the applied profile(s).

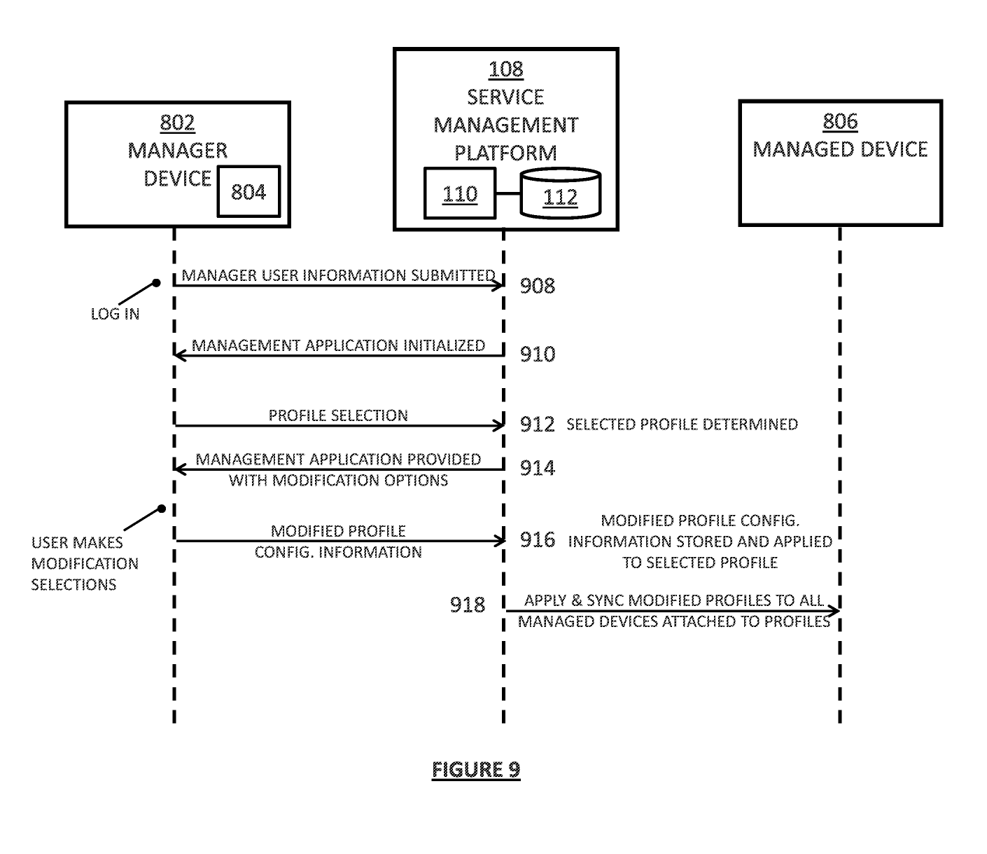

FIG. 9 is an operating and timing diagram showing management of a managed device 806, including the interaction between some of the elements described in FIG. 8. While there are certain elements shown in FIG. 8 that are not illustrated in FIG. 9 and vice versa, one of ordinary skill in the art would be able to advantageously describe with respect to one figure in order to achieve the advantages described herein for operation with the embodiment shown in other figures. All such embodiments are understood by one of ordinary skill in the art to be encompassed within the present specification.

In the illustrated embodiment, profiles for managed devices 806 are managed and modified at a service management platform 108 via a manager interface 804 of a manager device 802. As discussed above in relation to FIG. 8, profiles are governed by one or more selected policies. Policy examples may include time restrictions, internet restrictions, website restrictions, limits on the number of text messages, password requirements, location tracking, download restrictions, etc. Further, a plurality of profiles may be configured and stored at the database 112 for managing one or more respective managed devices 806. The detailed management actions may include the following:

Manager device 802 logs in to a user account at the service management platform 108 via manager interface 804. The manager device 802 may be a mobile telephone, tablet, other mobile device, computer, or similar device. The manager interface 804 may be a mobile phone application, web browser application, or the like. Thus, the manager device 802 requests made to the service management platform 108 may originate at a mobile device. At action 908, service the service management platform 108 receives manager user information (e.g., user name, password) provided at the manager interface 804.

At action 910, the service management platform 108 initializes a management application at the manager interface 804 for presentment of content at the manager interface 804. At action 912, the service management platform 108 receives a profile selection from the manager device 802. The profile selection may identify which profile (or profiles) in the manager device user's account should be modified. The service management platform 108 determines the selected profile(s) for modification based on the profile selection received from the manager device 802. At action 914, the service management platform 108 provides modification options to the manager device interface 804 for presentment to the manager device user. The manager device user makes modification selections.

At action 916, the service management platform 108 receives modified profile configuration information associated with the selected profile(s) from the manager device 802, and the modified profile configuration information is applied to modify the selected profile(s). The modified profile(s) are stored in a manager user account in database 112 at the service management platform 108. Thus, modified profile(s) may be governed by one or more modified, added, or deleted management policies.

At action 918, the service management platform 108 applies and syncs modified profiles to the respective managed devices 806 attached to the profiles. Managed device 806 may be a mobile telephone, tablet, computer, or similar device. Further, there may be a plurality of managed devices 806 associated with a manager device 802. Thus, the manager device 802 may manage a plurality of managed devices 806 via the service management platform 108 and may modify a plurality of managed devices 806 by modifying a profile. For example, if a profile is attached to several managed devices, each managed device will be updated upon modification of that profile. Further, in an embodiment, manager device 802 and managed device 806 have different users.

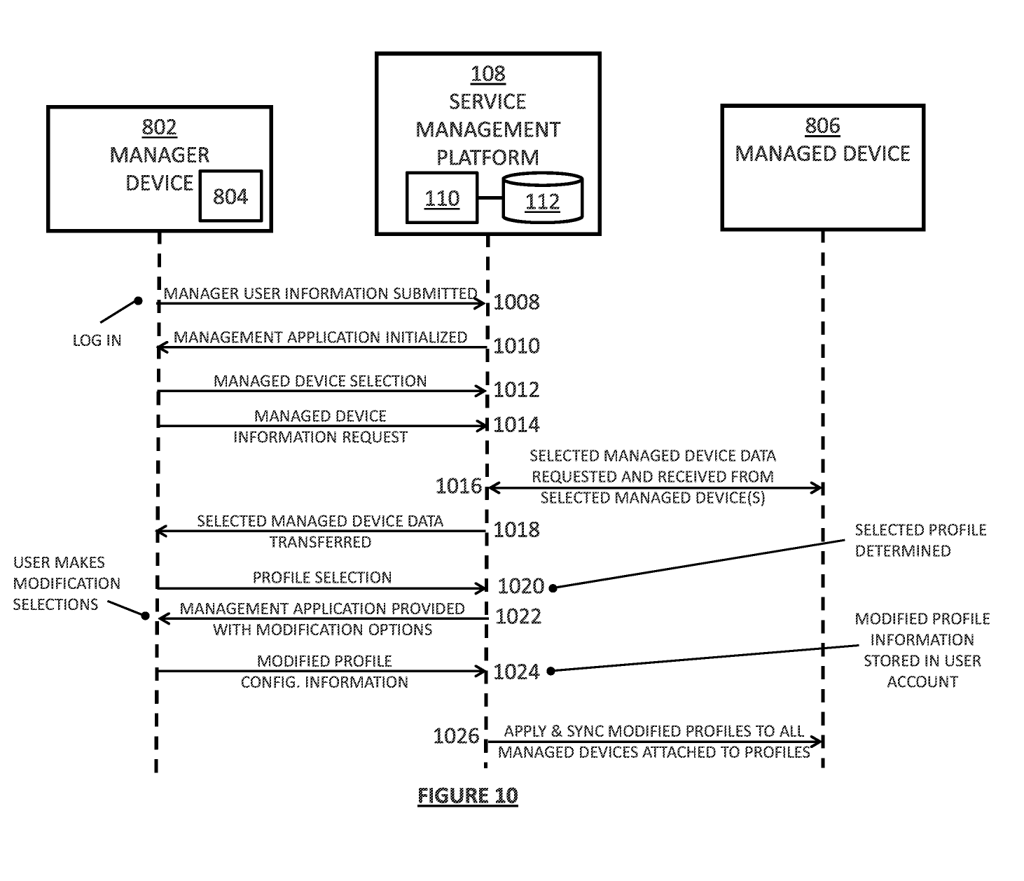

FIG. 10 is an operating and timing diagram showing monitoring of managed devices, including the interaction between some of the elements described in FIGS. 8 and 9. While there are certain elements shown in FIGS. 8 and 9 that are not illustrated in FIG. 10 and vice versa, one of ordinary skill in the art would be able to advantageously describe with respect to one figure in order to achieve the advantages described herein for operation with the embodiment shown in other figures. All such embodiments are understood by one of ordinary skill in the art to be encompassed within the present specification.

In the illustrated embodiment, managed devices 806 are monitored at a manager interface 804 of a manager device 802 via a service management platform 108. The detailed monitoring actions may include the following:

Manager device 802 logs in to a user account at the service management platform 108 via manager interface 804. The manager device 802 may be a mobile telephone, tablet, other mobile device, computer, or similar device. The manager interface 804 may be a mobile phone application, web browser application, or the like. Thus, the manager device 802 requests may originate at a mobile device. At action 1008, service management platform 108 receives manager user information (e.g., user name, password) provided at the manager interface 804.

At action 1010, the service management platform 108 initializes a management application at the manager interface 804 for presentment of content at the manager interface 804. At action 1012, the service management platform 108 receives a managed device selection from the manager device 802. The managed device selection may include a selection of one or more managed device(s) 806. Managed device 806 may be a mobile telephone, tablet, computer, or similar device. Further, there may be a plurality of managed devices 806 associated with a manager device 802. Thus, the manager device 802 may monitor a plurality of managed devices 806 via the service management platform 108. Further, in an embodiment, manager device 802 and managed device 806 have different users.

At action 1014, the service management platform 108 receives a managed device information request from the manager device 802 via the manager interface 804. In an embodiment, the managed device selection and managed device information request are received substantially simultaneously at the service management platform 108. In other embodiments, the managed device selection and the managed device information request are received sequentially. The managed device information request may include a request for the managed device's usage data. For example, usage data may include a request for information such as trend charts, application or service usage, location information, whether the managed device is current engaged in a phone call, whether the managed device is currently texting, whether the managed device is currently using the internet, what websites the managed device is looking at or has looked at, and/or other information related to the managed device(s) 806.

At action 1016, the service management platform 108 requests and receives the selected managed device data from the selected managed device(s) 806. At action 1018, the service management platform 108 transfers the selected managed device data related to the selected managed device(s) 806 to the manager interface 804. The managed device data may include usage data. In an embodiment, the selected managed device data is received by the service management platform 108 and provided to the manager device 802 substantially in real-time. For example, the service management platform 108 may receive and provide real-time data to the manager device 802, such as whether the managed device 806 is currently engaged in a phone call, the managed device's 806 location, whether the managed device 806 is using the internet, etc. In other embodiments, the selected managed device data is collected and aggregated by the service management platform 108 and provided to the manager device 802 with some delays, or, in some embodiments, as an aggregated data report of various managed device usages over a period of time.

In an embodiment, the manager device user may optionally modify profiles based on and/or in response to data received during the monitoring process. Modifying profiles may be performed in a similar manner to the actions discussed with respect to FIG. 9.

For example, at action 1020, the service management platform 108 may optionally receive a profile selection from the manager device 802. The profile selection may identify which profile (or profiles) in the manager device user's account should be modified. The service management platform 108 determines the selected profile(s) for modification based on the profile selection received from the manager device 802. At action 1022, the service management platform 108 provides modification options to the manager device interface 804 for presentment to the manager device user. The manager device user makes modification selections.

At action 1024, the service management platform 108 receives modified profile configuration information associated with the selected profile(s) from the manager device 802, and the modified profile configuration information is applied to modify the selected profile(s). The modified profile(s) are stored in a manager user account in database 112 at the service management platform 108. Thus, modified profile(s) may be governed by one or more modified, added, or deleted management policies.

At action 1026, the service management platform 108 applies and syncs modified profiles to the respective managed devices 806 attached to the profiles. Managed device 806 may be a mobile telephone, tablet, computer, or similar device. Further, there may be a plurality of managed devices 806 associated with a manager device 802. Thus, the manager device 802 may manage a plurality of managed devices 806 via the service management platform 108 and may modify a plurality of managed devices 806 by modifying a profile. For example, if a profile is attached to several managed devices, each managed device will be updated upon modification of that profile. Further, in an embodiment, manager device 802 and managed device 806 have different users.

Thus, the managed devices may be governed by one or more modified, additional, or deleted management policies in response to usage data received by the service management platform 108 and provided to the manager device 802 during the monitoring process.

By way of example only, the manager device 802 has a parent user, and three managed devices 806 have child users. One of the child users is substantially older than the other child users. Accordingly, the parent user may configure profiles for the two younger child users' managed devices that are different than profiles configured for the older child user's managed device. For example, the profile associated with the younger child users' managed devices may restrict internet access and downloads without a password known only to the parent, which would require the younger child users to only access the internet and/or initiate downloads in the presence of their parent. The profile associated with the older child may not require such restrictions, and, instead may only restrict internet access from the older child user's device based on certain predetermined restricted sites.

Accordingly, the service management platform 108 provides a robust and convenient way for a manager to configure, manage, and monitor managed devices' services and usages through configuration, management, and modification of profiles governed by usage policies, through selective application of profiles to respective managed devices, and through monitoring managed devices' usages.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of provisioning, at a manager mobile device via a service management platform, mobile device services for one or more managed mobile devices, the method comprising:
receiving, at the service management platform, manager user information from the manager mobile device via a manager mobile device interface;
initializing, by the service management platform, the management application at the manager mobile device interface;
receiving, at the service management platform, a management profile from the manager mobile device interface, the service profile governed by one or more management policies;
storing, at a service management platform database, the management profile received from the manager mobile device interface; and
provisioning the one or more managed mobile devices by applying the management profile.

2. The method of claim 1, wherein the one or more managed mobile devices are different mobile devices than the manager mobile device.

3. The method of claim 2, wherein the one or more managed mobile devices are associated with respective one or more managed device users, and wherein the one or more managed device users are different than a user associated with the manager mobile device.

4. The method of claim 1, further comprising:
receiving, at the service management platform, a managed device identifier from the manager mobile device interface; and
storing, at a service management platform database, the managed device identifier received from the manager mobile device interface,
wherein the managed device identifier comprises one or more of managed device number, mobile identification number (MIN), hardware identification number, SIM card identity, electronic serial number, and international mobile equipment identity (IMEI).

5. The method of claim 4, further comprising receiving, at the service management platform, a request for provisioning a managed mobile device, the request comprising a managed device selection and a management profile selection.

6. The method of claim 5, further comprising storing the request at the service management platform database.

7. The method of claim 6, wherein storing the request comprises storing the request for one or more selected managed device identifiers associated with one or more respective selected management profiles.

8. The method of claim 5, wherein provisioning the one or more managed mobile devices further comprises:
identifying a selected managed mobile device based on the managed device selection; and
applying selected management profile to the selected managed mobile device based on the management profile selection.

9. The method of claim 5, wherein provisioning the one or more managed mobile devices is performed in response to receiving the request originating from the mobile manager device.

10. A method of modifying, at a manager mobile device via a service management platform, mobile device management profiles for one or more managed mobile devices, the method comprising:
receiving, at the service management platform, manager user information from the manager mobile device via a manager mobile device interface;
initializing, by the service management platform, the management application at the manager mobile device interface;
receiving, at the service management platform, a profile selection from the manager mobile device interface;
receiving, at the service management platform, a modified management profile configuration from the manager mobile device interface, the modified management profile governed by one or more modified management policies;
storing, at a service management platform database, the modified management profile received from the manager mobile device interface; and
provisioning the one or more managed mobile device by applying the modified management profile.

11. The method of claim 10, wherein the one or more managed mobile devices are associated with respective one or more management profiles, and wherein the provisioning further comprises applying the one or more modified management profiles to managed devices associated with the modified service profiles.

12. The method of claim 10, wherein applying the modified management profile allows for the one or more managed mobile devices to be governed by the one or more modified management policies.

13. A method for monitoring one or more managed mobile devices from a manager mobile device via a service management platform, the method comprising:
receiving, at the service management platform, manager user information from the manager mobile device via a manager mobile device interface;
initializing, by the service management platform, the management application at the manager mobile device interface;
receiving, at the service management platform, a managed device selection from the manager mobile device interface;
receiving, at the service management platform, a managed device information request from the manager mobile device interface;
transmitting, to the manager mobile device interface, managed device data associated with the managed device based on the managed device information request, the managed device data received from the managed device comprising usage data.

14. The method of claim 13, further comprising requesting and receiving managed device data from a managed device associated with the managed device selection and based on the managed device selection.

15. The method of claim 13, further comprising:
receiving, at the service management platform, a profile selection from the manager mobile device interface; and
receiving a modified management profile from the manager mobile device interface, the modified management profile comprising one or more modified management policies in response to the managed device data received from the managed device.

16. The method of claim 15, further comprising:
storing, at a service management platform database, the modified management profile received from the manager mobile device interface; and
provisioning the one or more managed mobile devices by applying the modified managed profiles to respective managed mobile devices.

17. The method of claim 13, wherein usage data comprises one of trend charts, service usage, and application usage associated with the managed device.

18. The method of claim 13, further comprising transmitting, to the manager mobile device interface, managed device data received in real-time.

19. A system for provisioning mobile device services for one or more managed mobile devices, the system comprising:
a service management platform in communication with a manager device interface of a manager device associated with a manager device user, and further in communication with one or more managed devices associated with one more respective managed device users, the service management platform comprising:
a service management platform database operable to store one or more management profiles and one or more managed device identifiers, the one or more managed device identifiers associated with respective of the one or more managed devices; and
a service management platform server in communication with the service management platform database; and
wherein the service management platform is operable to receive, at the platform server, manager user information from the manager mobile device via a manager mobile device interface,
to initialize the management application at the manager mobile device interface,
to receive, at the platform server, a management profile from the manager mobile device interface, the management profile governed by one or more management policies,
to store, at the service management platform database, the management profile received from the manager mobile device interface, and
to provision the one or more managed mobile devices by applying the management profile.

20. The system of claim 19, wherein the service management platform is further operable to receive, at the service management server, a managed device identifier from the manager mobile device interface, and
to store, at the service management platform database, the managed device identifier received from the manager mobile device interface,
wherein the managed device identifier comprises one or more of managed device number, mobile identification number (MIN), hardware identification number, SIM card identity, electronic serial number, and international mobile equipment identity (IMEI).

21. The system of claim 20, wherein the service management platform is further operable to receive, at the service management platform server, a request for provisioning a managed mobile device, the request comprising a managed device selection and a management profile selection, and
to store the request, for one or more selected managed device identifiers associated with one or more respective selected management profiles, at the service management platform database.

22. The system of claim 21, wherein the service management platform is further operable to identify a selected managed mobile device based on the managed device selection, and apply a selected management profile to the selected managed mobile device based on the management profile selection.

23. The system of claim 19, wherein the service management platform is further operable to receive a profile selection from the manager mobile device interface, and to receive a modified management profile associated with the profile selection from the manager mobile device interface, the modified management profile governed by one or more modified management policies,
wherein the service management platform is further operable to store, at the service management platform database, the modified management profile received from the manager mobile device interface, and
wherein the service management platform is further operable to provision the one or more managed mobile devices by applying the modified management profile.

24. The system of claim 23, wherein the one or more managed mobile devices are associated with respective one or more management profiles, and wherein the service management platform is further operable to apply the modified management profile to managed devices associated with the modified management profile.

25. The system of claim 19, wherein the service management platform is further operable to provide monitoring of one or more managed mobile devices to a manager mobile device interface, and
wherein the service management platform receives a managed device selection and a managed device information request from the manager mobile device interface, and
wherein the service management platform transmits, to the manager mobile device interface, managed device data associated with the managed device based on the managed device information request, the managed device data comprising usage data received from the managed device.

26. The system of claim 25, wherein usage data comprises one of trend charts, service usage, and application usage associated with the managed device.

27. The system of claim 25, wherein the service management platform transmits, to the manager mobile device interface, managed device data substantially in real-time.

28. The system of claim 25, wherein the service management platform is operable to request and receive managed device data from a managed device associated with the managed device selection and based on the managed device information request.
